(19) United States
(12) Patent Application Publication
(10) Pub. No.: US 2004/0054571 A1
(43) Pub. Date: Mar. 18, 2004

(54) On-line system for hospitals to schedule and hire nurses through nursing registries

(75) Inventors: Shirley H. Yu, Santa Ana, CA (US); Gerry Hazelton, Santa Ana, CA (US); Neelam Kumari, Santa Ana, CA (US)

Correspondence Address: CHARLES C.H. WU, ESQ., WU & CHEUNG, LLP, SUITE 710, 7700 IRVINE CENTER DRIVE, IRVINE, CA, 92618-3043, US

(73) Assignee: CARENET HEALTH SYSTEM

(21) Appl. No.: 10/244,975

(22) Filed: Sep. 18, 2002

(51) Int. Cl. G06F 17/60

(52) U.S. Cl. 705/8

(57) ABSTRACT

An on-line system for hospitals to schedule and hire nurses through nursing registries is disclosed. The system provides a main computer server connected to the Internet with a number of hospital databases, nursing registry databases and nurses databases distributed over the main computer server in a way permitting authorized nurse and nursing agency users to access and modify these databases via computers connected to the Internet. The system also permits authorized hospital users to access these databases via computers connected to the Internet and implement scheduling and hiring nurses as well as posting requests for nurses.

### FIELD OF THE INVENTION

The present invention relates to an on-line system for hospitals to schedule and hire nurses through nursing registries. More specifically, the system of this invention allows hospitals and medical centers to fill the required nursing positions by way of searching registries' databases or posting requests to the registries via the Internet.

### BACKGROUND OF THE INVENTION

In the United States, nursing registries provide alternative means of full time or part time employment for many nurses. Hospitals often require to fill in temporary nursing positions due to, for example, illness or other unavailability of a nurse employed by the hospital. In such situations, hospitals would contact nursing registries and request a nurse of a specified discipline to fill in a position for a specified period of time. A nursing registry would locate an available nurse matching the requested qualifications and arrange for the nurse's filling in at the requesting hospital. Since it is illegal in all states for a nurse to work with an expired license or CPR (cardio pulmonary resuscitation) certification, nursing registries are also charged with a duty to insure that the nurses they supply to hospitals have their licenses and CPR current.

Conventionally, a charge nurse in a hospital in need of a nurse to fill in a temporary position would call a nursing registry and make a request, specifying the desired criteria for the nurse. The nursing registry would then try to locate the matching candidate and call the hospital back, advising whether or not a suitable nurse has been found. In case there is cancellation, either the hospital or the nursing registry would make a call to advise of the cancellation. There may be several back and forth telephone calls between the hospital and the nursing registry before the nurse is finally hired and the schedules are confirmed.

With the advent of the Internet, more and more business is transacted on line. There is a clear need for an on-line system for hospitals to schedule and hire nurses through registries.

### SUMMARY OF THE INVENTION

The system of this invention satisfies this need by providing a main computer server connected to the Internet with a number of hospital databases, nursing registry databases and nurses databases distributed over the main computer server in a way permitting authorized nurse and nursing agency users to access and modify these databases via computers connected to the Internet. The system also permits authorized hospital users to access these databases via computers connected to the Internet and implement scheduling and hiring nurses as well as posting requests for nurses. Specifically, the authorized hospital user enters a search criteria, such as a start date, a contracting nursing registry, a start time, an end date, an end time, a specialty, a discipline. In response to the entered search criteria the contracting nursing registries databases are accessed to match the search criteria with the available schedule records. An availability result is then retrieved, displayed and confirmed, including names of available nurses and the corresponding available start dates, available start times, available end dates, available end times, specialties, disciplines. If the availability result is zero, the authorized hospital user enters a posted request, including a start date, a contracting nursing registry, a start time, an end time, a specialty, a discipline. In response to the posted request entered by the authorized hospital user, an authorized contracting nursing registry user adds proposed schedules, including names of available nurses and the corresponding available start dates, available start times, available end times, specialties, disciplines. The proposed schedules are then displayed and confirmed.

### BRIEF DESCRIPTION OF THE DRAWING FIGURES

FIG. 1 through FIG. 10 depict web pages viewed by a user of an on-line system for hospitals to schedule and hire nurses through nursing registries according to this invention.

FIG. 11 is a block diagram of the system of the present invention.

### DETAILED DESCRIPTION OF THE PREFERRED EMBODIMENT

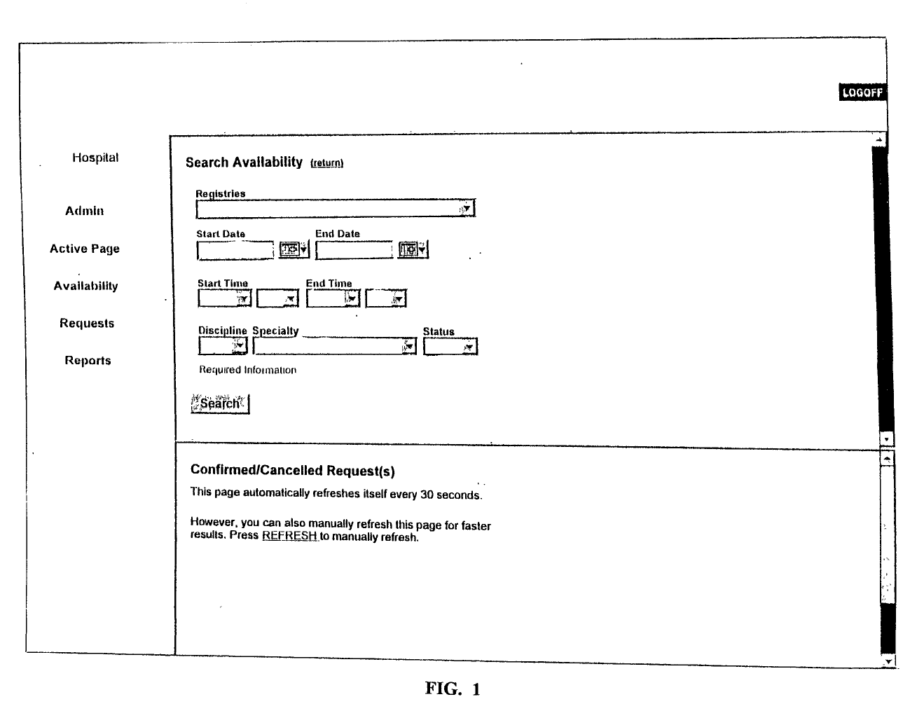

The present invention will be better understood with reference to FIG. 1 through FIG. 10 depicting web pages viewed by the user of the on-line system for hospitals to schedule and hire nurses through nursing registries according to the preferred embodiment of this invention.

Viewing FIG. 1, there is shown a means for entering a search criteria for a desired nurse, displayed on the screen of the authorized hospital user's computer. Specifically, there is a pull-down menu containing a list of contracting nursing registries, i.e. the nursing registries that have a contract with that particular hospital to supply nurses to fill in temporary positions. There are also boxes to enter a start date, a start time, an end date, an end time, a specialty, a discipline.

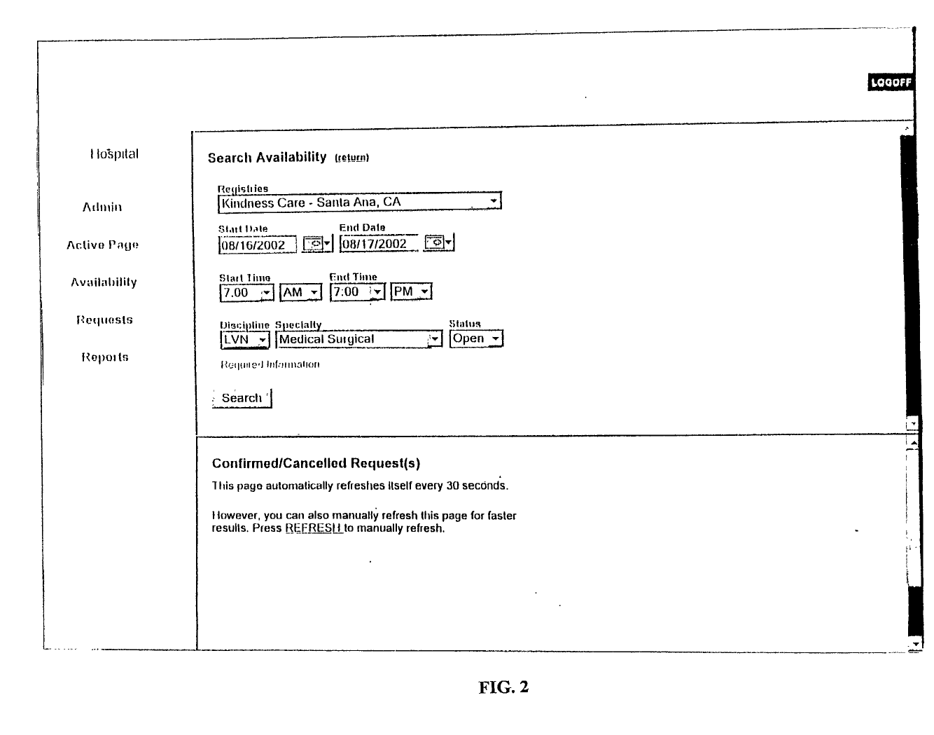

Viewing FIG. 2, there is shown the search criteria entered by the authorized hospital user. The selected registry is Kindness Care—Santa Ana, Calif.; the start date is selected Aug. 16, 2002; the end date is selected Aug. 17, 2002; the start time is selected 7:00 a.m.; the end time is selected 7:00 p.m.; the discipline is selected LVN (licensed vocational nurse) and the specialty is selected Medical Surgical.

Under control of the main computer server, in response to the above search criteria entered by the authorized hospital user, the database of Kindness Care—Santa Ana, Calif. will be accessed to match the search criteria with the available schedule records and an availability result will be retrieved. The availability result will comprise names of available nurses and the corresponding available start dates, available start times, available end dates, available end times, specialties, disciplines, wherein the availability result will not include the available nurses with expired license expiration dates or expired CPR expiration dates.

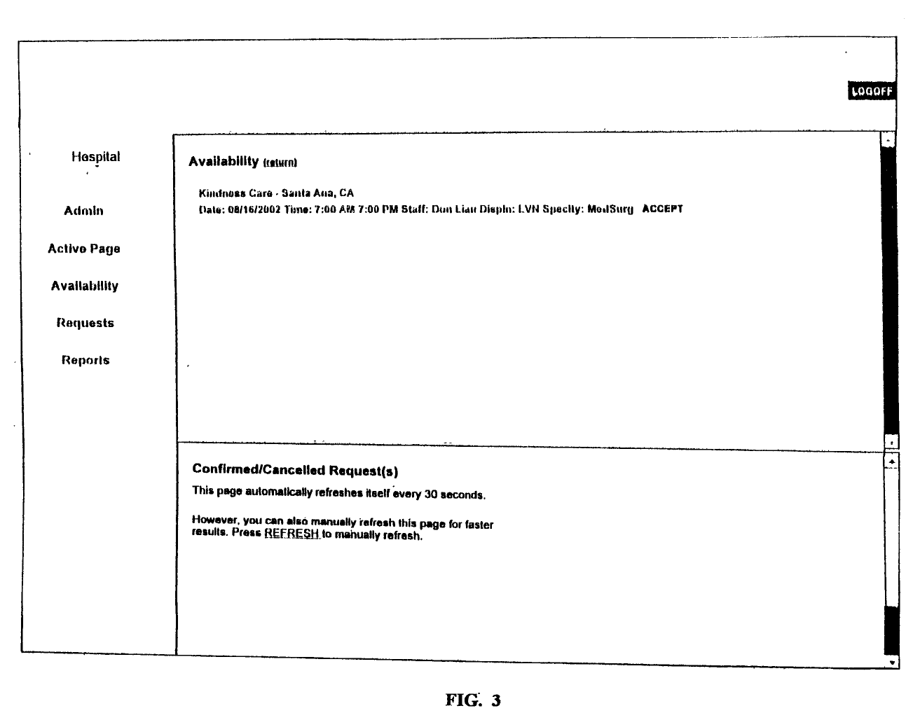

Viewing FIG. 3, there is shown the availability result (Kindness Care—Santa Ana, Calif.; Date: Aug. 16, 2002; Time: 7:00 a.m. to 7:00 p.m.; Staff: Don Liau; Discipline: LVN; Specialty: Medical Surgical) displayed on the screen of the authorized hospital user's computer, as well as means of accepting said availability result shown in FIG. 3 as “ACCEPT” button next to the schedule.

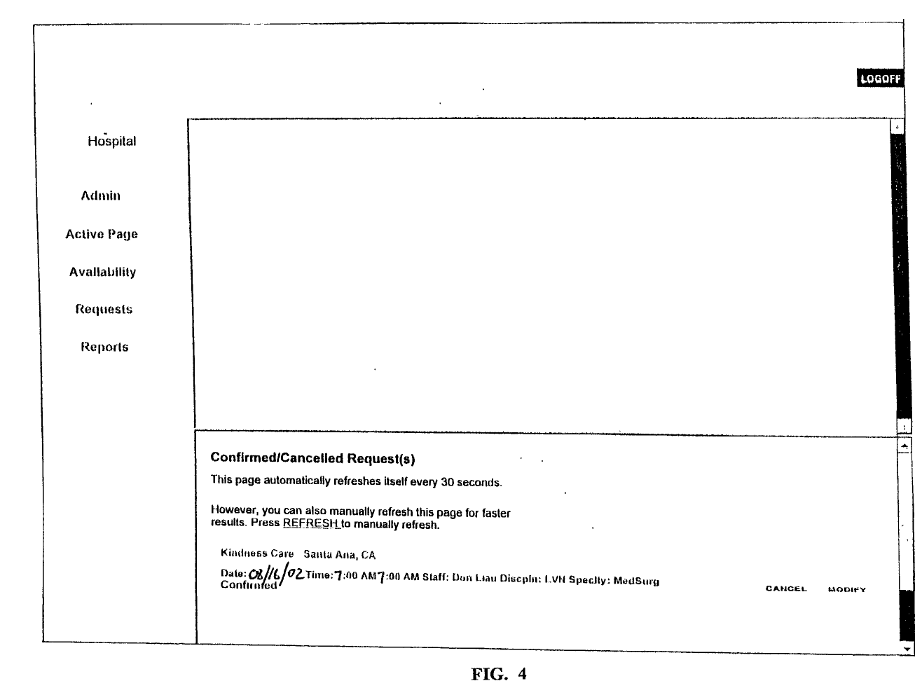

Viewing FIG. 4, under control of both the authorized contracting nursing registry user's computer and the authorized hospital user's computer, in response to accepting the availability result by clicking on the “ACCEPT” button, the availability result is displayed as a confirmed schedule.

Still viewing FIG. 4, there is shown means to cancel the confirmed schedules and means to modify the confirmed schedules by way of the “CANCEL” and “MODIFY” buttons next to the confirmed schedule. Clicking on the “CANCEL” button allows either the authorized hospital user or the authorized contracting nursing registry user to cancel the confirmed schedule. Clicking on the “MODIFY” button allows either the authorized hospital user or the authorized contracting nursing registry user to modify the confirmed schedule.

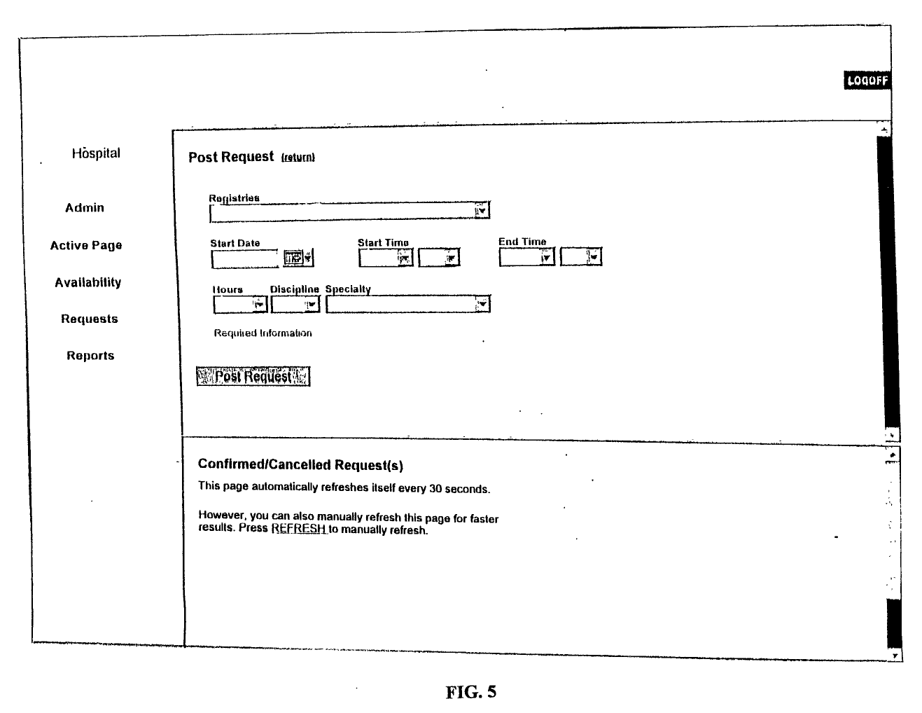

When the availability result is zero (i.e. there is no available nurses that match the search criteria), the main computer server provides means for the authorized hospital user to implement a method of posting requests for nurses. Viewing now FIG. 5, there is shown a means for entering a posted request for a desired nurse, displayed on the screen of the authorized hospital user's computer. Specifically, there is a pull-down menu containing a list of contracting nursing registries and the boxes to enter a start date, a start time, an end time, a specialty, a discipline.

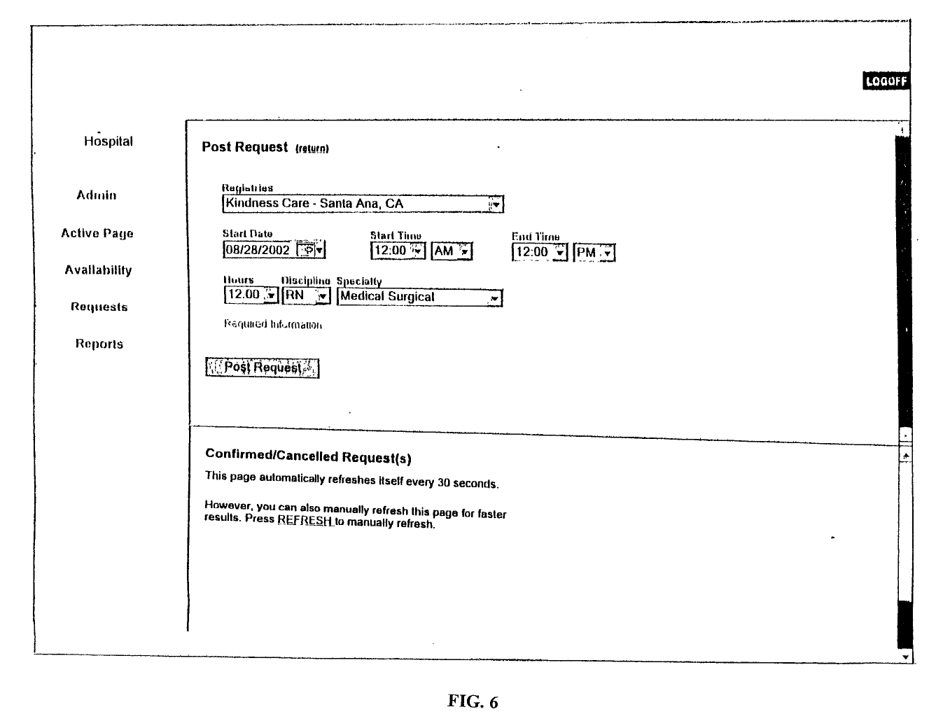

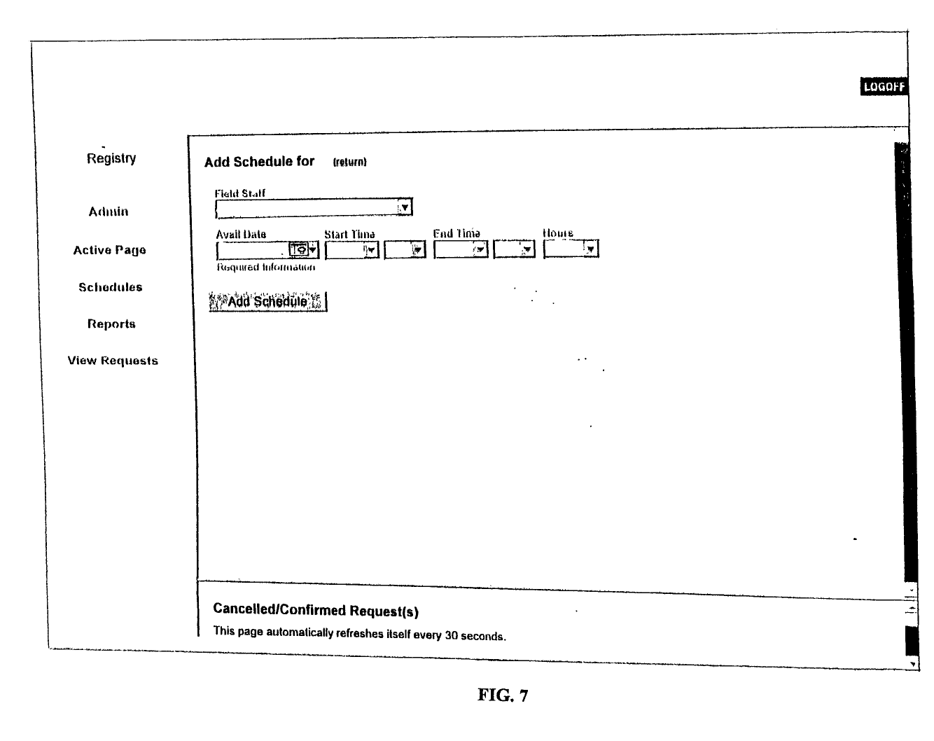

Viewing FIG. 6, there is shown the posted request entered by the authorized hospital user. The selected registry is Kindness Care—Santa Ana, Calif.; the start date is selected Aug. 28, 2002; the start time is selected 12:00 a.m.; the end time is selected 12:00 p.m.; the discipline is selected RN (registered nurse) and the specialty is selected Medical Surgical. The posted request will be displayed under control of the plurality of authorized contracting nursing registry users' computers, which will allow the registries to search their databases for available nurses matching the posted request. When a nurse matching the posted request is found, the registry can add proposed schedules for the hospital's acceptance. Specifically, viewing FIG. 7, there is shown means of adding proposed schedules, which has a pull-down menu with the names of the nurses in the registry's database, as well as boxes to enter an available date, start time, end time and the number of hours. There is also provided a button “Add Schedule”.

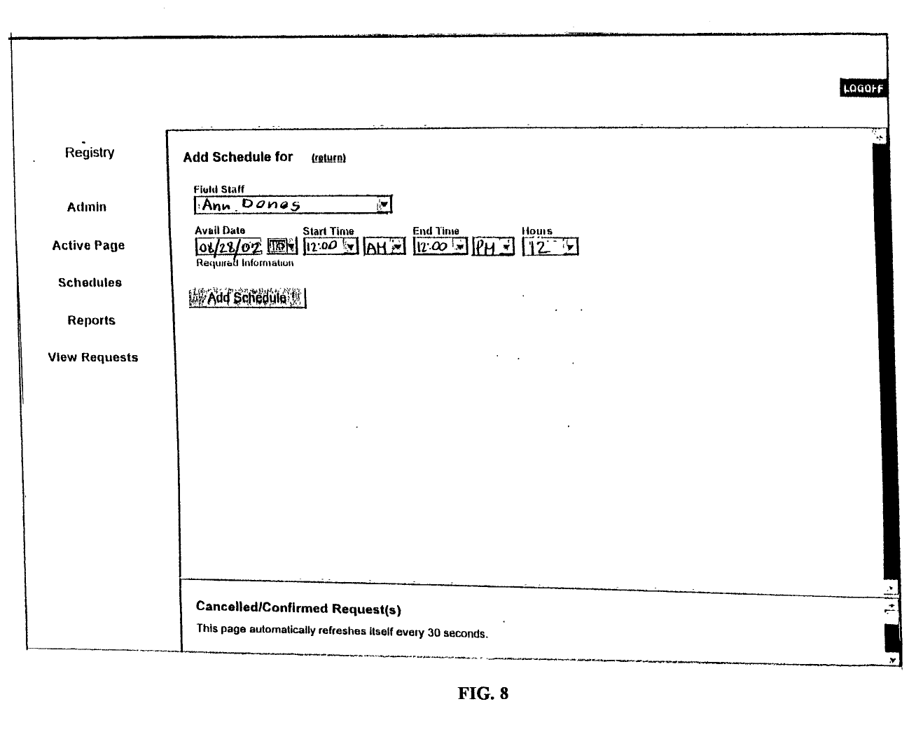

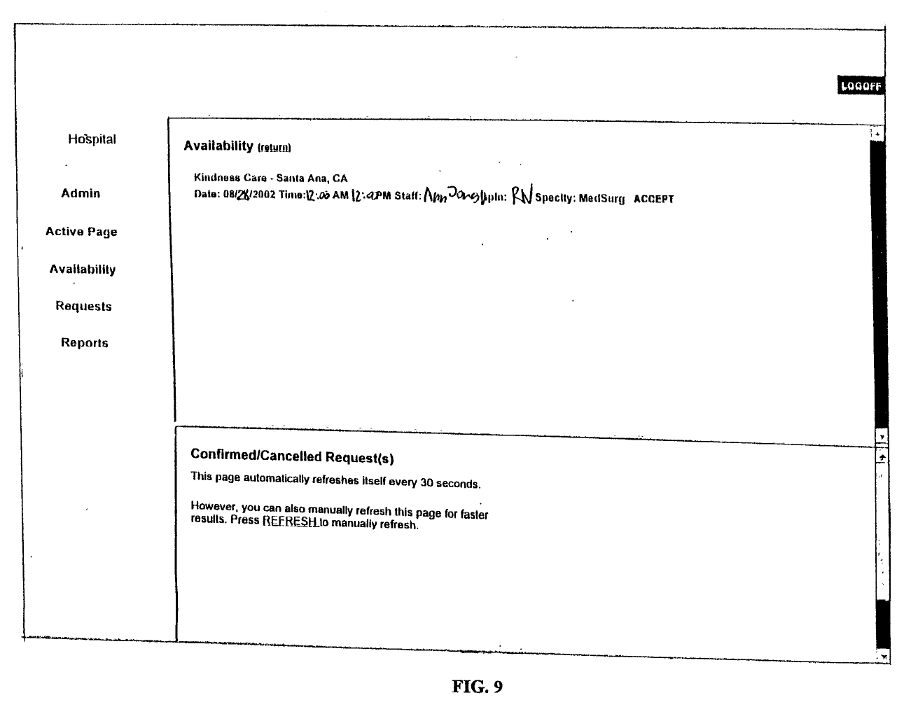

Viewing now FIG. 8, there is shown the information for the available nurse matching the posted request entered by the authorized contracting nursing registry user (Ann Jones, available date Aug. 28, 2002, start time 12:00 a.m., end time 12:00 p.m., hours 12). Clicking the “Add Schedule” button causes displaying the proposed schedule and displaying means of accepting the proposed schedules under control of the authorized hospital user's computer. Specifically, viewing now FIG. 9, there is shown the proposed schedule under the heading “Availability” (Kindness Care—Santa Ana, Calif.; Date: Aug. 28, 2002; Time: 12:00 a.m. to 12:00 p.m.; Staff: Ann Jones: RN; Specialty: Medical Surgical) displayed on the screen of the authorized hospital user's computer, as well as means of accepting the proposed schedule shown in FIG. 9 as “ACCEPT” button next to the schedule.

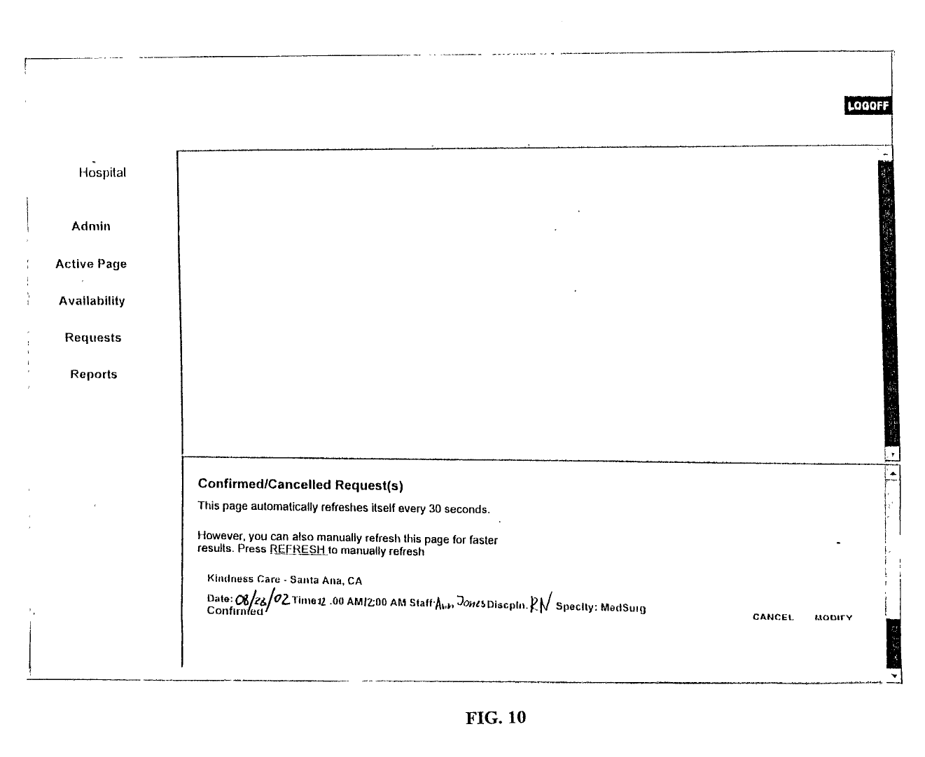

Viewing FIG. 10, under control of both the authorized contracting nursing registry user's computer and the authorized hospital user's computer, in response to accepting the proposed schedule by clicking on the “ACCEPT” button, the proposed schedule is displayed as a confirmed schedule.

Still viewing FIG. 10, there is shown means to cancel the confirmed schedules and means to modify the confirmed schedules by way of the “CANCEL” and “MODIFY” buttons next to the confirmed schedule. Clicking on the “CANCEL” button allows either the authorized hospital user or the authorized contracting nursing registry user to cancel the confirmed schedule. Clicking on the “MODIFY” button allows either the authorized hospital user or the authorized contracting nursing registry user to modify the confirmed schedule.

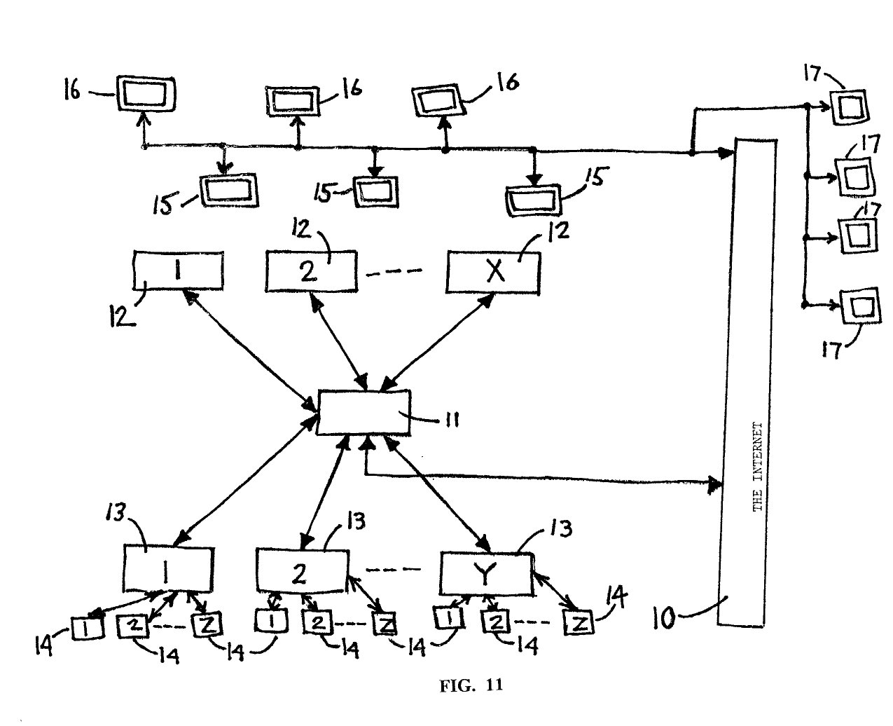

Viewing now FIG. 11, there is shown a block diagram of the system of the present invention. Numeral 10 indicates a computer network shown in FIG. 1 as the Internet. Numeral 11 indicates a main computer server connected to Computer Network 10. Numeral 12 indicates 1 through X hospital databases distributed over Main Computer Server 11, where X is an integer not smaller than 2. Each of Hospital Databases 12 comprises a plurality of authorized hospital users records.

Numeral 13 indicates 1 through Y nursing registry databases distributed over Main Computer Server 11, where Y is an integer not smaller than 2. Each of Nursing Registry Databases 13 further comprises 1 through Z nurses databases, indicated by numeral 14, distributed over Main Computer Server 11, where Z is an integer not smaller than 2. Each of the Nurses Databases 14 comprises a name record; a license number record; a license expiration date record; a cardio pulmonary resuscitation (CPR) expiration date record; a specialty record; a discipline record; a confirmed schedule record comprising a plurality of confirmed start date records, confirmed start time records, confirmed end date records, confirmed end time records; an available schedule record comprising a plurality of available start date records, available start time records, available end date records, available end time records;

Numeral 15 indicates an authorized nursing registry user's computer. A plurality of Authorized Nursing Registry User's Computers are connected to Computer Network 10. Main Computer Server 11 provides means for an authorized nursing registry user to access the corresponding Nursing Registry Database 13 via Authorized Nursing Registry User's Computer 15 and create, modify, delete and view selected name records, license number records, license expiration date records, CPR expiration date records, specialty records, discipline records, confirmed start date records, confirmed start time records, confirmed end date records, confirmed end time records, available start date records, available start time records, available end date records, available end time records.

Numeral 16 indicates an authorized nurse user's computer. A plurality of Authorized Nurse User's Computers 16 are connected to Computer Network 10. Main Computer Server 11 provides means for an authorized nurse user to access the corresponding Nursing Registry Database 13 via Authorized Nurse User's Computer 16 and create, modify, delete and view selected specialty records, discipline records, confirmed start date records, confirmed start time records, confirmed end date records, confirmed end time records, available start date records, available start time records, available end date records, available end time records.

Numeral 17 indicates an authorized hospital user's computer. A plurality of Authorized Hospital User's Computers 17 are connected to Computer Network 10. Main Computer Server 11 provides means for an authorized hospital user to access a plurality of contracting Nursing Registry Databases 13 via Authorized Hospital User's Computer 17 and implement a method of scheduling and hiring nurses as well as method of posting requests for nurses described in FIGS. 1 through 10.

What is claimed is:

1. An on-line system for hospitals to schedule and hire nurses through nursing registries, the system comprising:
(a) a main computer server connected to a computer network;
(b) 1 through X hospital databases distributed over the main computer server, where X is an integer not smaller than 2, each of the hospital databases comprising a plurality of authorized hospital users records;
(c) 1 through Y nursing registry databases distributed over the main computer server, where Y is an integer not smaller than 2, each of the nursing registry databases further comprising 1 through Z nurses databases distributed over the main computer server, where Z is an integer not smaller than 2, each of the nurses databases comprising:
(1) a name record;
(2) a license number record;
(3) a license expiration date record;
(4) a cardio pulmonary resuscitation (CPR) expiration date record;
(5) a specialty record;
(6) a discipline record;
(7) a confirmed schedule record comprising a plurality of confirmed start date records, confirmed start time records, confirmed end date records, confirmed end time records;
(8) an available schedule record comprising a plurality of available start date records, available start time records, available end date records, available end time records;
wherein each of the hospital databases further comprises a plurality of contracting registries records;
wherein the main computer server provides means for an authorized nursing registry user to access the corresponding nursing registry database via the authorized nursing registry user's computer connected to the computer network and create, modify, delete and view selected name records, license number records, license expiration date records, CPR expiration date records, specialty records, discipline records, confirmed start date records, confirmed start time records, confirmed end date records, confirmed end time records, available start date records, available start time records, available end date records, available end time records;
wherein the main computer server provides means for an authorized nurse user to access the corresponding nursing registry database via the authorized nurse user's computer connected to the computer network and create, modify, delete and view selected specialty records, discipline records, confirmed start date records, confirmed start time records, confirmed end date records, confirmed end time records, available start date records, available start time records, available end date records, available end time records;
wherein the main computer server provides means for an authorized hospital user to access a plurality of contracting nursing registries databases via the authorized hospital user's computer connected to the computer network and implement a method of scheduling and hiring nurses comprising the steps of:
(a) under control of the authorized hospital user's computer, displaying means for entering a search criteria, wherein the search criteria includes a start date and comprises at least one of the following: a contracting nursing registry, a start time, an end date, an end time, a specialty, a discipline;
(b) under control of the main computer server, in response to the search criteria entered by the authorized hospital user, accessing the plurality of contracting nursing registries databases to match said search criteria with the available schedule records and retrieving an availability result comprising names of available nurses and the corresponding available start dates, available start times, available end dates, available end times, specialties, disciplines, wherein the availability result will not include the available nurses with expired license expiration dates or expired CPR expiration dates;
(c) under control of the authorized hospital user's computer, displaying the availability result and displaying means of accepting said availability result;
(d) under control of both the authorized contracting nursing registry user's computer and the authorized hospital user's computer, in response to accepting said availability result entered by the authorized hospital user, displaying said availability result as confirmed schedules;
wherein when the availability result is zero, the main computer server provides means for the authorized hospital user to implement a method of posting requests for nurses comprising the steps of:
(e) under control of the authorized hospital user's computer, displaying means for entering a posted request, wherein the posted request includes a start date and comprises at least one of the following: a contracting nursing registry, a start time, an end time, a specialty, a discipline;
(f) under control of the plurality of authorized contracting nursing registry users' computers, in response to the posted request entered by the authorized hospital user, displaying said posted request and displaying means of adding proposed schedules, the proposed schedules comprising names of available nurses and the corresponding available start dates, available start times, available end times, specialties, disciplines, wherein the proposed schedules will not include the available nurses with expired license expiration dates or expired CPR expiration dates;
(g) under control of the authorized hospital user's computer, in response to the adding proposed schedules by the authorized contracting nursing registry user, displaying said proposed schedules and displaying means of accepting the proposed schedules;
(h) under control of both the authorized contracting nursing registry user's computer and the authorized hospital user's computer, in response to the accepting the proposed schedules entered by the authorized hospital user, displaying said proposed schedules as confirmed schedules.

2. A system as in claim 1, wherein the method of scheduling and hiring nurses further comprises the step of:
(d1) under control of both the authorized contracting nursing registry user's computer and the authorized hospital user's computer, displaying means to cancel the confirmed schedules and means to modify the confirmed schedules;
wherein the means to cancel the confirmed schedules allow either the authorized hospital user or the authorized contracting nursing registry user to cancel the confirmed schedules and wherein the means to modify the confirmed schedules allow either the authorized hospital user or the authorized contracting nursing registry user to modify the confirmed schedules;
wherein the method of posting requests for nurses further comprises the step of:
(i1) under control of both the authorized contracting nursing registry user's computer and the authorized hospital user's computer, displaying means to cancel the confirmed schedules and means to modify the confirmed schedules.
wherein the means to cancel the confirmed schedules allow either the authorized hospital user or the authorized contracting nursing registry user to cancel the confirmed schedules and wherein the means to modify the confirmed schedules allow either the authorized hospital user or the authorized contracting nursing registry user to modify the confirmed schedules;

3. A system as in claim 2, wherein the computer network is the Internet and wherein the means to access the hospital databases, the registry databases and the nurses databases comprises a web page accessible via the Internet.
